(19) United States
(12) Patent Application Publication
(10) Pub. No.: US 2013/0057884 A1
(43) Pub. Date: Mar. 7, 2013

(54) INFORMATION PROCESSING APPARATUS, COMPUTER PROGRAM, AND CONTROL METHOD

(71) Applicant: Koji SASAKI, Kanagawa (JP)

(72) Inventor: Koji SASAKI, Kanagawa (JP)

(73) Assignee: RICOH COMPANY, LIMITED, Tokyo (JP)

(21) Appl. No.: 13/597,490

(22) Filed: Aug. 29, 2012

(30) Foreign Application Priority Data
Sep. 7, 2011 (JP) 2011-195117

(51) Int. Cl. G06K 15/02

(52) U.S. Cl. 358/1.9

(57) ABSTRACT

An information processing apparatus includes: a retaining unit that retains condition information to control an output setting of first output data based on a predetermined condition; a receiving unit that receives second output data obtained by dividing the first output data into pieces each having a predetermined amount of data; and a first determining unit that determines whether to control the output setting of the first output data based on the second output data, having the predetermined amount of data, and the condition information.

### CROSS-REFERENCE TO RELATED APPLICATIONS

The present application claims priority to and incorporates by reference the entire contents of Japanese Patent Application No. 2011-195117 filed in Japan on Sep. 7, 2011.

### BACKGROUND OF THE INVENTION

1. Field of the Invention

The present invention relates to an information processing apparatus, a computer program product, and a control method.

2. Description of the Related Art

A technique is conventionally known (see, for example, Japanese Patent Application Laid-open No. 2003-228474) in which, when a user makes a instruction to execute a print job in a user device such as a personal computer, a cost incurred in producing an output of the print job is displayed on a display screen and the user is allowed to decide whether to continue with, or abort, the print job.

In this related-art technique, providing the user with information on an output cost prior to start of the print job prompts the user to reduce a print cost and to change an output destination or a print setting (a setting of an output form, such as, color printing, monochrome printing, or a recording medium), so that reduction in the output cost can be achieved.

In the related-art technique described above, however, decision of change of the output destination and the print setting is left to the user, which poses a problem in that it cannot be ensured that reduction in the output cost intended by a system administrator is achieved. In addition, the related-art technique poses another problem in that changing the output destination or the print setting in order to achieve reduction in the output cost creates extra work for the user.

There is a need to provide an information processing apparatus, a computer program product, and a control method that can reduce the output cost in accordance with an intention of a system administrator without creating any extra work for a user.

### SUMMARY OF THE INVENTION

It is an object of the present invention to at least partially solve the problems in the conventional technology.

An information processing apparatus includes: a retaining unit that retains condition information to control an output setting of first output data based on a predetermined condition; a receiving unit that receives second output data obtained by dividing the first output data into pieces each having a predetermined amount of data; and a first determining unit that determines whether to control the output setting of the first output data based on the second output data, having the predetermined amount of data, and the condition information.

A computer program product includes a non-transitory computer-usable medium having computer-readable program codes embodied in the medium. The program codes when executed causing a computer to function as: an acquiring unit that acquires, from a retaining unit that retains condition information to control an output setting of first output data based on a predetermined condition, the condition information; and a first determining unit that determines whether to control the output setting of the first output data based on second output data and the condition information acquired by the acquiring unit, the second output data being obtained by dividing the first output data into pieces each having a predetermined amount of data and being received by a receiving unit.

A control method is performed by an information processing apparatus that comprises a control unit. The control method includes steps, performed by the control unit, of: receiving second output data obtained by dividing first output data into pieces each having a predetermined amount of data; acquiring, from a retaining unit that retains condition information to control an output setting of the first output data based on a predetermined condition, the condition information; and making a first determination that determines whether to control the output setting of the first output data based on the second output data, having the predetermined amount of data, and the condition information acquired at the step of acquiring.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a schematic configuration of an information processing system according to an embodiment of the present invention;

FIG. 2 is a block diagram illustrating a hardware configuration of a print server device and a client terminal device;

FIG. 3 is a block diagram illustrating a hardware configuration of a control system for an image forming device configured as a laser printer;

FIG. 4 is a block diagram illustrating a hardware configuration of a control system for an image forming device configured as a multifunctional peripheral (MFP);

FIG. 5 is a block diagram illustrating a functional configuration of each device;

FIG. 6 is a schematic view illustrating an exemplary configuration of a cost information table;

FIG. 7 is a schematic view illustrating an exemplary configuration of a rule information table;

FIG. 8 is a flowchart illustrating processing procedure performed by the print server device; and

FIG. 9 is a schematic view illustrating a structure of print data.

### DETAILED DESCRIPTION OF THE PREFERRED EMBODIMENTS

An embodiment of the present invention will be described below with reference to the accompanying drawings.

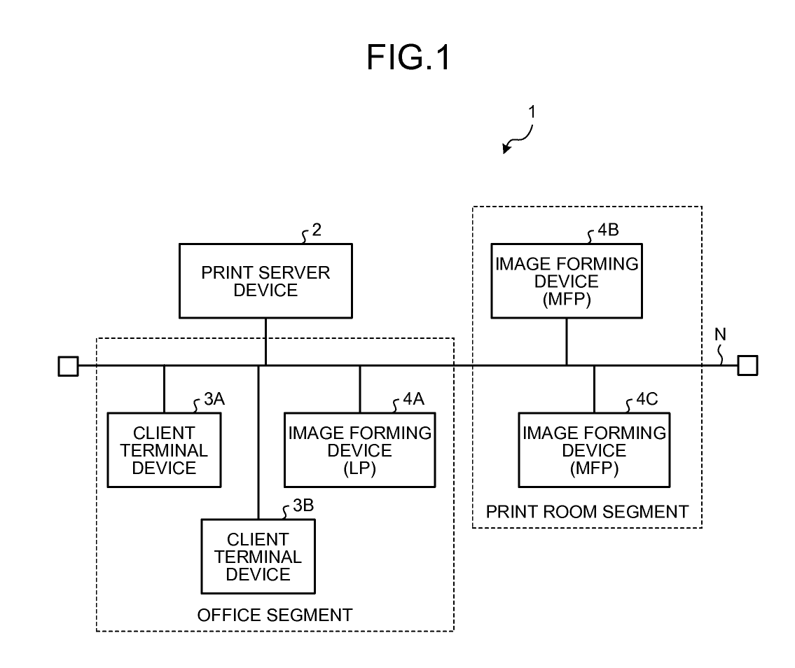

A configuration of an information processing system 1 according to the present embodiment of the present invention will be described below with reference to FIG. 1. FIG. 1 is a block diagram illustrating a schematic configuration of the information processing system 1 according to the embodiment of the present invention.

As illustrated in FIG. 1, the information processing system 1 includes a print server device 2, a plurality of client terminal devices 3 (two are exemplarily illustrated in FIG. 1), and a plurality of image forming devices 4 (three are exemplarily illustrated in FIG. 1). These devices are connected to each other to be capable of mutual communication with each other over a network N, such as a local area network (LAN).

The print server device 2 has a print server application operating thereon, manages a print job that includes one or a plurality pieces of print data and transmits the print data constituting the print job to the image forming device 4 to thereby cause the image forming device 4 to perform the print job.

The client terminal device 3 is a terminal device used by a user and to transmit one or more pieces of print data constituting the print job based on a print instruction by the user. The client terminal device 3 is constituted by, for example, a personal computer (PC) or a portable information terminal.

The image forming device 4 is capable of forming (printing) an image on a recording medium, such as recording paper, based on the print data received from the print server device 2.

In the information processing system 1, an image forming device 4A is configured as a laser printer (LP) and an image forming device 4B and an image forming device 4C are configured as a multifunctional peripheral (MFP) having at least two functions of a copier function, a scanner function, a facsimile (fax) function, and a printer function. Any image forming device not specifically identified will hereinafter be referred to simply as the image forming device 4.

Additionally, in the information processing system 1, a client terminal device 3A, a client terminal device 3B, and the image forming device 4A are placed in an office space (segment) and the image forming device 4B and the image forming device 4C are placed in a print room space (segment). In other words, the image forming device 4A is placed close to the client terminal device 3A and the client terminal device 3B, while the image forming device 4B and the image forming device 4C are placed remotely from the client terminal device 3A and the client terminal device 3B.

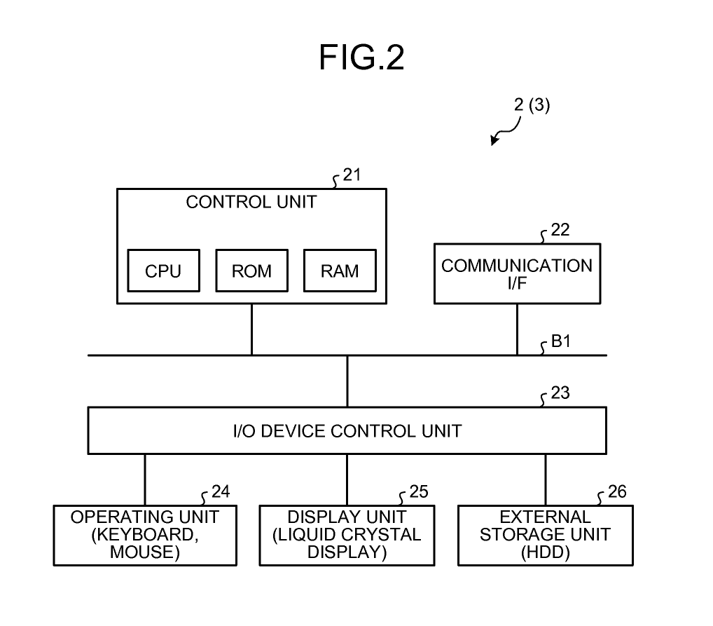

A hardware configuration of the print server device 2, the client terminal device 3, and the image forming device 4 constituting the information processing system 1 will be described below with reference to FIGS. 2 to 4.

FIG. 2 is a block diagram illustrating a hardware configuration of the print server device 2 and the client terminal device 3.

As illustrated in FIG. 2, the print server device 2 and the client terminal device 3 have a normal hardware configuration utilizing a computer, such as a PC, and include, for example, a control unit 21, a communication interface (I/F) 22, and an I/O device control unit 23 connected to each other via a bus B1.

The control unit 21 includes, for example, a central processing unit (CPU), a read only memory (ROM), and a random access memory (RAM).

In addition, for example, an operating unit (e.g., a keyboard or a mouse) 24, a display unit (e.g., a liquid crystal display) 25, an external storage unit (e.g., a hard disk drive (HDD) or a solid state drive (SSD)) 26 are connected to the control unit 21 via the bus B1 and the I/O device control unit 23.

Thus, in the control unit 21, the CPU deploys a control program stored in the ROM, the external storage unit 26, etc. into the RAM and executes the control program to control operation of the devices connected thereto via the I/O device control unit 23 and to control operation of transmitting and receiving various types of data to and from other devices connected via the communication I/F 22 and the network N.

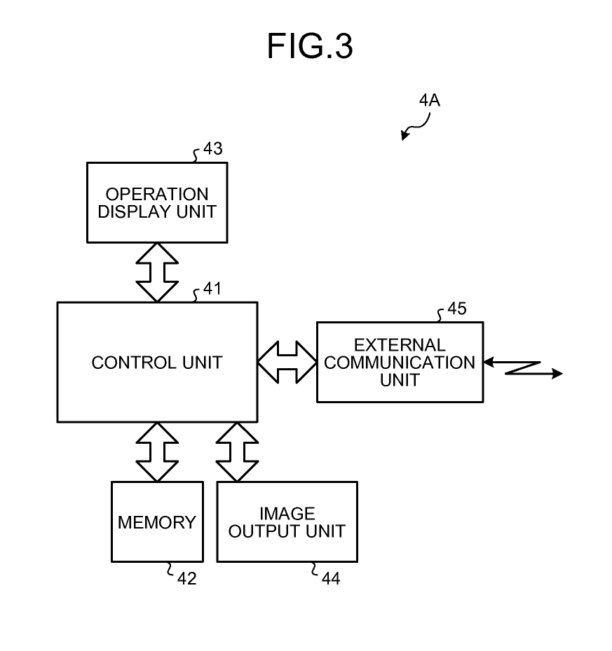

FIG. 3 is a block diagram illustrating a hardware configuration of a control system for the image forming device 4A configured as a laser printer.

As illustrated in FIG. 3, the image forming device 4A includes, for example, a control unit 41, a memory 42, an operation display unit 43, an image output unit 44, and an external communication unit 45.

The control unit 41 controls the whole of the image forming device 4A, specifically, various types of processing including drawing processing, communication processing, and input processing and display processing for the operation display unit 43. The control unit 41 may include, for example, a central processing unit (CPU), a read only memory (ROM), and a random access memory (RAM).

The memory 42 is storage to temporarily store therein print data received over the network N by the external communication unit 45, expanded image data, etc.

The operation display unit 43 is a user interface that displays an operating method of using various types of functions of the image forming device 4A and accepts operating inputs from the user.

The image output unit 44 forms an image on a recording medium, such as recording paper, based on print data stored in the memory 42, etc.

The external communication unit 45 performs communication with the outside, and has a communication function for such as IEEE1394 and LAN.

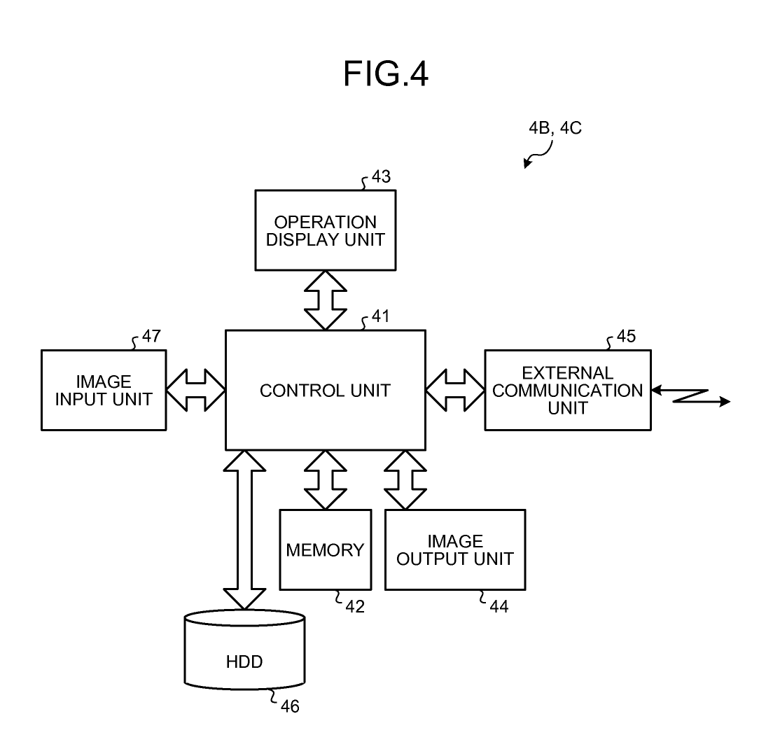

FIG. 4 is a block diagram illustrating a hardware configuration of a control system of the image forming device 4B and the image forming device 4C configured as a MFP.

As illustrated in FIG. 4, the image forming device 4B and the image forming device 4C have a configuration including an HDD 46 and an image input unit 47 in addition to the control unit 41, the memory 42, the operation display unit 43, the image output unit 44, and the external communication unit 45, which are substantially identical to those of the above-described hardware configuration of the image forming device 4A configured as the laser printer.

The control unit 41 controls the whole of the image forming device 4B or the image forming device 4C, specifically, various types of processing including drawing processing, communication processing, and input processing and display processing for the operation display unit 43. The control unit 41 may include, for example, a CPU, ROM, and RAM.

The memory 42 is storage to temporarily store therein print data received over the network N by the external communication unit 45, expanded image data, etc.

The operation display unit 43 is a user interface that displays an operating method of using various types of functions of the image forming device 4B or the image forming device 4C and accepts an operating input from the user.

The image output unit 44 outputs an image, and forms an image on a recording medium, such as recording paper, based on image data (print data) created from, for example, an image input by the image input unit 47.

The external communication unit 45 performs communication with the outside, and has a communication function for such as IEEE1394, USB, and LAN.

The HDD 46 is storage to store therein print data received by the external communication unit 45.

The image input unit 47 inputs an image. Configured, for example, as a scanner, the image input unit 47 reads an image of a document placed on a document table and input the image.

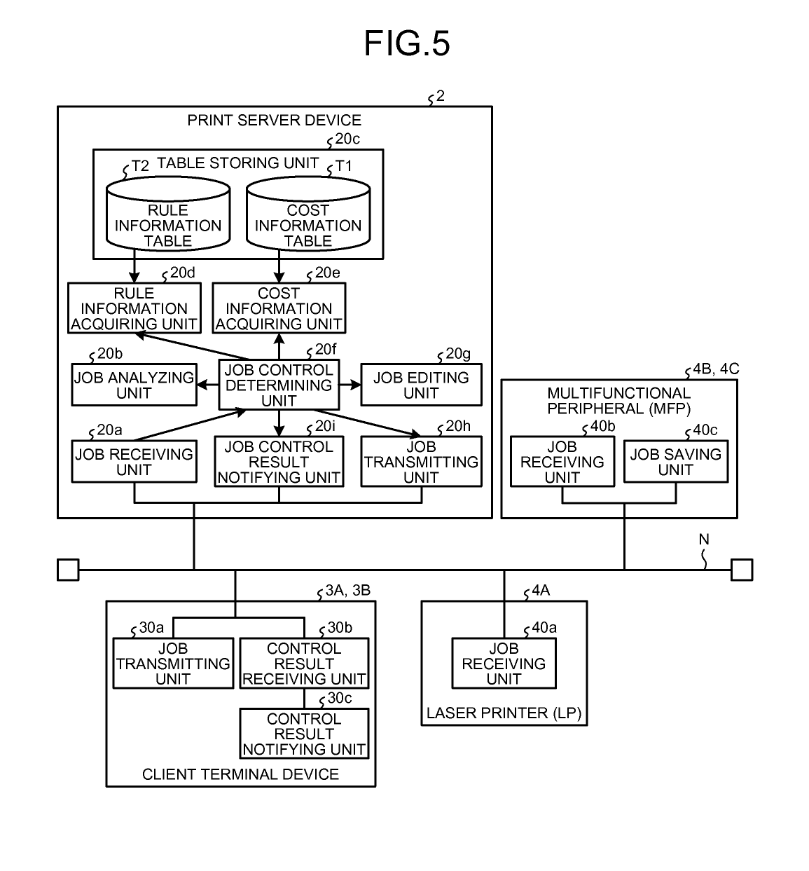

A functional configuration of the devices constituting the information processing system 1 will be described below with reference to FIG. 5. FIG. 5 is a block diagram illustrating the functional configuration of the devices.

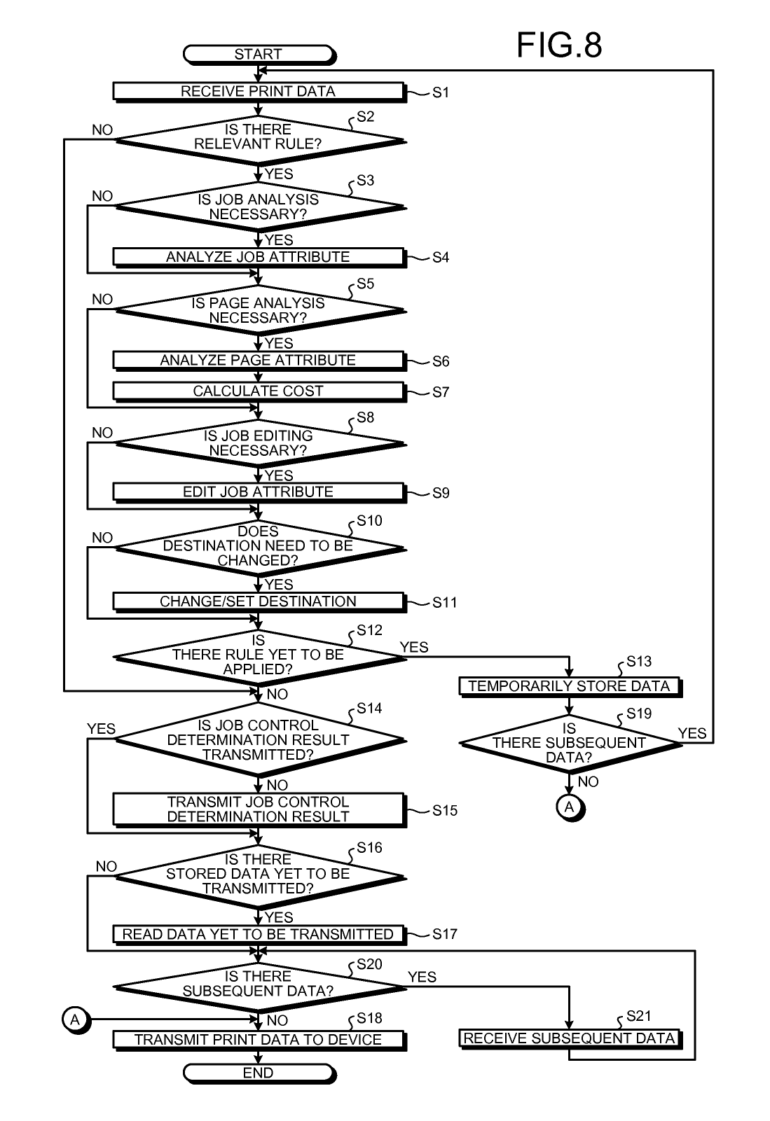

The control unit 21 (CPU) of the print server device 2 deploys a predetermined control program stored in the ROM, the external storage unit (HDD) 26, etc. into, for example, the RAM and executes the predetermined control program. As illustrated in FIG. 5, the control unit 21 thereby functions as a job receiving unit 20a, a job analyzing unit 20b, a table storing unit 20c, a rule information acquiring unit 20d, a cost information acquiring unit 20e, a job control determining unit 20f, a job editing unit 20g, a job transmitting unit 20h, and a job control result notifying unit 20i that perform processing steps illustrated in FIG. 8 described later.

Here, the job receiving unit 20a receives a print job from the client terminal device 3.

The job analyzing unit 20b analyzes attribute information of the print job received by the job receiving unit 20a, if a predetermined condition to reduce an output cost is satisfied.

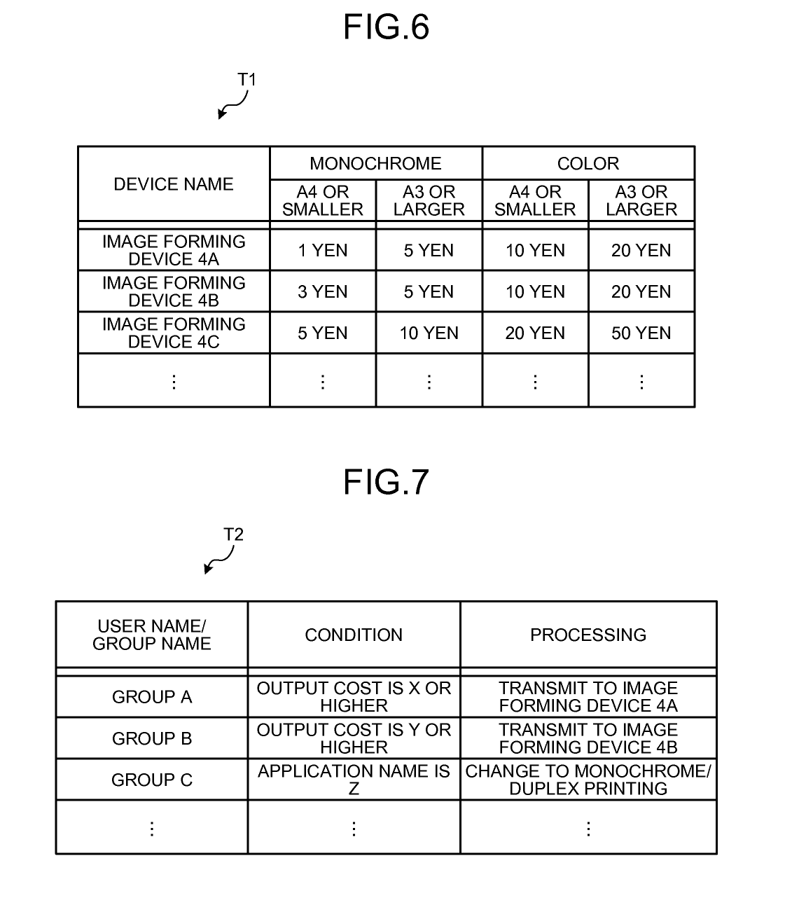

The table storing unit 20c reads information to calculate the output cost of the print job in each of the image forming devices 4 from the external storage unit 26 and stores, for example, a cost information table T1 (see FIG. 6), that retains cost information indicating a unit cost per sheet, and a rule information table T2 (see FIG. 7), that retains rule information defining a print control method, in a table storage area on the RAM.

FIG. 6 is a schematic view illustrating an exemplary configuration of the cost information table T1.

In an example illustrated in FIG. 6, the cost information table T1 registers: an output cost (a unit cost per sheet) of monochrome printing using recording paper of A4; an output cost (a unit cost per sheet) of monochrome printing using recording paper of A3 or larger; an output cost (a unit cost per sheet) of color printing using recording paper of A4 or smaller; and an output cost (a unit cost per sheet) of color printing using recording paper of A3 or larger, for each of the image forming devices 4 as cost information.

The cost information table T1 indicates that the output cost of the image forming device 4A is lowest and the output cost of the image forming device 4C is highest.

FIG. 7 is a schematic view illustrating an exemplary configuration of the rule information table T2.

In an example illustrated in FIG. 7, the rule information table T2 registers, to achieve cost reduction, a predetermined condition and a type of processing to be performed (a change to be made) when the predetermined condition is satisfied, in an associated manner for each group. Specifically, the rule information table T2 registers rule information that includes: a rule that, when a print job relating to a user who belongs to a group A satisfies a predetermined condition that “the output cost is X or higher”, print data relating to the print job is to be transmitted to the image forming device 4A; a rule that, when a print job relating to a user who belongs to a group B satisfies a predetermined condition that “the output cost is Y or higher”, print data relating to the print job is to be transmitted to the image forming device 4B; and a rule that, when a print job relating to a user who belongs to a group C satisfies a predetermined condition that “the name of the application (to be used) is Z”, an attribute (output form) relating to the print job is forcedly changed to monochrome and duplex printing.

Specific details of the cost information table T1 and the rule information table T2 illustrated in FIGS. 6 and 7, respectively, can be arbitrarily set by the system administrator using a predetermined information terminal.

Referring back to FIG. 5, the rule information acquiring unit 20d acquires rule information from the rule information table T2 when a predetermined condition for cost reduction is satisfied.

The cost information acquiring unit 20e acquires cost information from the cost information table T1 when a predetermined condition for cost reduction is satisfied.

The job control determining unit 20f determines the print control method for the print job received by the job receiving unit 20a based on job analysis information representing an analysis result of the job analyzing unit 20b, the rule information acquired by the rule information acquiring unit 20d, and the cost information acquired by the cost information acquiring unit 20e.

The job editing unit 20g edits the attribute of the print job received by the job receiving unit 20a when the job control determining unit 20f determines that a change of the attribute of the print job is necessary.

The job transmitting unit 20h transmits, when the job control determining unit 20f determines an output destination of a print job, the print job with the output destination thus determined to the corresponding image forming device 4.

The job control result notifying unit 20i transmits a control result to notify a change in the output destination or the output form to the client terminal device 3.

The control unit 21 (CPU) of the client terminal device 3 deploys a predetermined control program stored in the ROM, the external storage unit (HDD) 26, etc. into the RAM, etc. and executes the predetermined control program. As illustrated in FIG. 5, the control unit 21 thereby functions as a job transmitting unit 30a, a control result receiving unit 30b, and a control result notifying unit 30c.

Here, the job transmitting unit 30a transmits print data that constitutes the print job to the print server device 2 based on a print instruction from the user.

The control result receiving unit 30b receives the abovementioned control result from the print server device 2.

The control result notifying unit 30c performs notification processing of letting the user recognize the abovementioned control result received by the control result receiving unit 30b using the display unit 25, etc.

The control unit 41 of the image forming device 4A (LP) deploys a predetermined control program stored in the ROM, etc. into the RAM, etc. and executes the predetermined control program. As illustrated in FIG. 5, the control unit 41 thereby functions as a job receiving unit 40a.

Here, the job receiving unit 40a receives the print job over the network N.

The control unit 41 of the image forming device 4B (MFP) and the image forming device 4C (MFP) deploys a predetermined control program stored in the ROM, etc. into the RAM, etc. and executes the predetermined control program. As illustrated in FIG. 5, the control unit 41 thereby functions as a job receiving unit 40b and a job saving unit 40c.

Here, the job receiving unit 40b receives the print job over the network N.

The job saving unit 40c saves the print job received by the job receiving unit 40b in the HDD 46, etc.

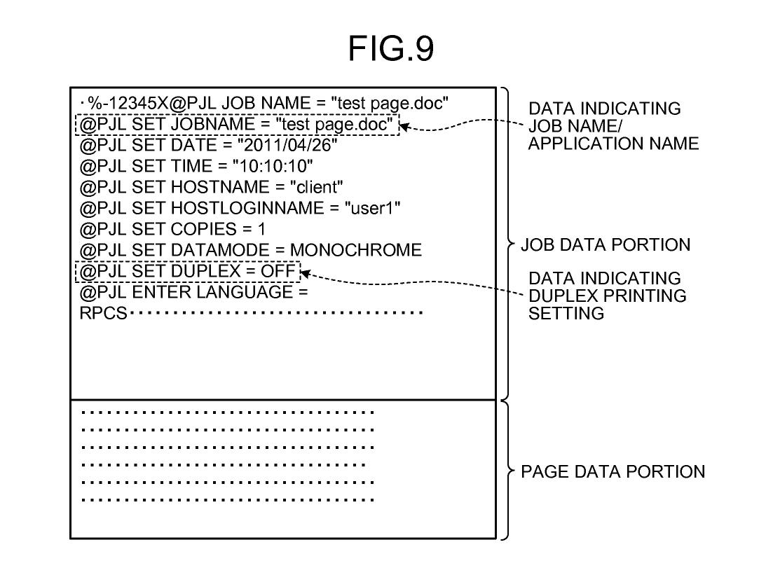

Processing operations performed by the print server device 2 will be described below with reference to FIGS. 8 and 9.

FIG. 8 is a flowchart illustrating processing procedure performed by the print server device 2.

As illustrated in FIG. 8, the job receiving unit 20a of the print server device 2 receives print data (see FIG. 9) transmitted from the client terminal device 3 (Step S1). The print data referred here is to constitute a single print job and may be each of multiple pieces of print data into which entire print data for the single print job is divided depending on an amount of the entire print data and according to a network (or system) rule. The print data may be transmitted as is without being divided if its amount of data is small.

FIG. 9 is a schematic view illustrating a structure of the print data. As illustrated in FIG. 9, the print data may be broadly classified into two data portions of different natures. Specifically, the print data includes a job data portion (a first data field) that stores therein attribute information, such as print conditions, and a page data portion (a second data field) that stores therein information on contents to be printed on a recording medium, such as recording paper. The attribute information includes, for example, data indicating a job name and an application name, data indicating whether duplex printing is involved, and data indicating a user name and a user group name. In general, the print data is transmitted from the client terminal device 3 in units of a predetermine amount of data in order from the job data portion to the page data portion.

Referring back to FIG. 8, when the print data is received at Step S1, the job analyzing unit 20b subsequently analyzes the job data portion of the print data to thereby acquire a user name or a user group name contained in the job data portion; the rule information acquiring unit 20d searches through the rule information table T2 using the user name or the user group name acquired by the job analyzing unit 20b as a key for any relevant rule associated with the user name or the user group name (that is, a rule to be applied to the print data received), thereby determining whether there is any relevant rule (Step S2).

If the print data received does not contain any user name or user group name and thus any user name or user group name cannot be acquired at Step S2, processing returns to Step S1 to thereby receive next print data (the predetermined amount of print data yet to be transmitted) from the client terminal device 3. During reception of print data relating to the single print job a second time and thereafter, the above extraction processing may be skipped because search for the relevant rule is completed.

If there is found an relevant rule as a result of the search performed at Step S2 (Yes at Step S2), the job control determining unit 20f determines whether a job analysis is necessary in order to determine whether the rule should be applied to the print data based on the relevant rule (Step S3).

Specifically, in the processing at Step S3, if the relevant rule is a rule (the condition and processing) relating to the job name/application name {for example, the rule associated with the group C in the rule information table T2 illustrated in FIG. 7 (the condition of “the application name is Z” and processing of “changing to monochrome/duplex printing”)}, the job control determining unit 20f determines that a job analysis is necessary, because the rule entails information to be acquired through a job analysis (application name). Similarly, if the relevant rule is a rule (condition and processing) relating to, for example, the output cost {for example, the rule associated with the group A in the rule information table T2 illustrated in FIG. 7 (the condition of “the output cost is X or higher” and processing of “transmitting to the image forming device 4A”)}, the rule entails information to be acquired through a job analysis (simplex/duplex, color/monochrome, number of copy sets, etc.) and the job control determining unit 20f determines that a job analysis is necessary. In contrast, if the relevant rule is a rule that does not require any analysis of the job data portion (for example, the rule relating to a content of the page data (e.g., the condition of “page data does not contain any image (containing characters only)” and processing of “monochrome”), the job control determining unit 20f determines that no job analysis is required.

If it is determined that a job analysis is necessary as a result of the determination made at Step S3 (Yes at Step S3), the job analyzing unit 20b then analyzes the job data portion (attribute information) of the print data received to thereby acquire information required (application name) to determine the condition in the rule (Step S4).

Specifically, if the relevant rule is a rule (the condition and processing) relating to the job name/application name {for example, the rule associated with the group C in the rule information table T2 illustrated in FIG. 7 (the condition of “the application name is Z” and processing of “monochrome/duplex printing”)}, the job analyzing unit 20b, in performing the processing at Step S4, analyzes @PJL SET JOBNAME of the job data portion of the print data received (see FIG. 9) to thereby acquire the job name/application name.

If the job analyzing unit 20b is unable to complete analysis of the job data portion of the print data received, that is, if all portions of the print data to be analyzed in the job data portion are yet to be received, the job analyzing unit 20b returns a result indicating that the job analysis is yet to be completed and stops the analysis. The result may be temporarily stored in, for example, the memory.

If it is determined that a job analysis is not necessary as a result of the determination made at Step S3 (No at Step S3), or after the processing of the analysis is performed at Step S4, the job control determining unit 20f determines whether a page analysis is necessary to determine whether the rule is to be applied to the print data based on the relevant rule (Step S5).

Specifically, in the processing at Step S5, if the relevant rule is a rule (the condition and processing) relating to a cost, the job control determining unit 20f determines that a job analysis is necessary, because the rule entails information to be acquired through a page analysis (e.g., the number of pages). In contrast, if the relevant rule is a rule (the condition and processing) relating to the job name/application name {for example, the rule associated with the group C in the rule information table T2 illustrated in FIG. 7 (the condition of “the application name is Z” and processing of “monochrome/duplex printing”)}, the job control determining unit 20f determines that no page analysis is required.

If it is determined that the page analysis is necessary as a result of the determination made at Step S5 (Yes at Step S5), the job analyzing unit 20b then analyzes a page attribute (e.g., page size and page color) of the print data received to thereby acquire information required to determine the condition in the rule (Step S6).

Specifically, in the processing at Step S6, the job analyzing unit 20b analyzes the page data portion (see FIG. 9) of the print data received to thereby acquire page information.

If the job analyzing unit 20b is unable to complete analysis of the page data portion from the print data received, that is, if all portions of the print data to be analyzed in the page data portion is yet to be received, the job analyzing unit 20b returns a result indicating that the page analysis is yet to be completed and stops the analysis. The result may be temporarily stored in, for example, the memory.

Next, the cost information acquiring unit 20e searches through the cost information table T1 using information that identifies a specific image forming device specified by the user as the output destination (e.g., an image forming device name), contained in, for example, the job data portion of the print data received, as a key. The cost information acquiring unit 20e thereby extracts cost information associated with the image forming device name {for example, information associated with the image forming device 4A in the cost information table T1 illustrated in FIG. 6 (the unit cost per sheet “¥1” for monochrome printing using recording paper of a size of A4 or smaller, the unit cost per sheet “¥5” for monochrome printing using recording paper of a size of A3 or larger, the unit cost per sheet “¥10” for color printing using recording paper of a size of A4 or smaller, and a unit cost per sheet “¥20” for color printing using recording paper of a size of A3 or larger)}. Using the cost information thus extracted and the page information acquired at Step S6, the cost information acquiring unit 20e calculates a cost of the print job for the print data received (Step S7).

If all information required for calculating the cost is not analyzed in the page analysis at Step S6, the cost information acquiring unit 20e returns a result indicating that the cost could not be calculated and stops the processing. The result may be temporarily stored in, for example, the memory.

If the information that identifies the image forming device as the output destination is not contained in the job data portion of the print data and, instead, is contained in a print request transmitted from the client terminal device 3, the information may be acquired from the print request.

If it is determined that the page analysis is not necessary as a result of the determination made at Step S5 (No at Step S5), or after the processing of the cost calculation at Step S7 is performed, the job control determining unit 20f determines whether job editing is necessary based on the results of processing at Steps S4, S6, and S7 (Step S8).

Specifically, in the processing at Step S8, if the relevant rule is a rule (the condition and processing) relating to the job name/application name and if the information acquired by the job analysis at Step S4 indicates that the rule is applicable, the job control determining unit 20f determines that job editing is necessary. In contrast, if the relevant rule is other than the rule relating to, for example, the job name/application name, the job control determining unit 20f determines that the job editing is not necessary.

For example, at Step S8, if the relevant rule is a rule associated with the group C in the rule information table T2 illustrated in FIG. 7 (the condition of “the application name is Z” and processing of “changing to monochrome/duplex printing”), the job control determining unit 20f determines whether information necessary for determination is acquired at Step S4 (whether the application name is acquired from the job data portion). If it is determined that the information is acquired, the job control determining unit 20f determines, based on the information thus acquired, whether the rule is satisfied (whether the application name acquired from the job data portion is Z).

If the rule is satisfied, the job control determining unit 20f determines that the job editing is necessary. If the information cannot be acquired, the rule is not satisfied, or the print data received is not sufficient (that is, a portion of print data to be subjected to job editing is yet to be received), the job control determining unit 20f determines that the job editing is not necessary. If, at Step S8, the relevant rule is a rule associated with the group A in the rule information table T2 of FIG. 7 (the condition of “the output cost is X or higher” and processing of “transmitting to the image forming device 4A”), the job control determining unit 20f determines that the job editing is not necessary.

If it is determined that the job editing is necessary as a result of the determination made at Step S8 (Yes at Step S8), the job editing unit 20g edits the job attribute of the print data received (Step S9).

Specifically, in the processing at Step S9, the job editing unit 20g changes setting at @PJL SET DUPLEX in the job data portion of the print data received from OFF to ON and changes setting at @PJL SET DATAMODE from COLOR to MONOCHROME.

If it is determined that the job editing is not necessary as a result of the determination made at Step S8 (No at Step S8), or after the processing at Step S9 is completed, the job control determining unit 20f determines, based on the results at Steps S4, S6, and S7, whether the transmission destination of the print job needs to be changed (Step S10).

Specifically, in the processing at Step S10, for example, if the relevant rule retrieved at Step S2 is a rule relating to the cost and the output cost calculated at Step S7 satisfies a predetermined condition included in the rule relating to the cost (e.g., the output cost is X or higher), and if the image forming device specified by the user as the output destination yields an output cost higher than in the image forming device defined by the processing (e.g., transmitting to the image forming device 4A) included in the rule relating to the cost, the job control determining unit 20f determines that the transmission destination for the print job needs to be changed.

If it is determined as a result of the determination made at Step S10 that the transmission destination in the print job needs to be changed (Yes at Step S10), the job transmitting unit 20h changes the transmission destination in the print job (Step S11). For example, in the processing at Step S11, the output destination is changed to, for example, an image forming device defined by the processing included in the rule relating to the cost retrieved at Step S2.

If it is determined as a result of the determination made at Step S10 that the transmission destination in the print job does not need to be changed (No at Step S10), or after the processing of changing the transmission destination at Step S11 is performed, the job control determining unit 20f determines whether there is existing any rule yet to be applied (Step S12).

Here, the expression “there is existing any rule yet to be applied” refers to a condition in which application of the relevant rule is yet to be completed because of the subsequent print data being yet to be analyzed. For example, if the relevant rule retrieved at Step S2 is one that requires the page analysis, that is, a rule relating to the cost, there may be a case in which print data yet to be received need to be received for further analysis because only the print data received at Step S1 is not sufficient to determine whether the rule is to be applied.

In other words, the print server device 2 according to the embodiment of the present invention receives print data piecemeal, the predetermined amount of data at a time, from the client terminal device 3 and determines whether the rule is to be applied. There may therefore be a case in which all information required to determine whether the rule is to be applied is not acquired at a particular point in time at which the predetermined volume of print data is received.

Thus, if the analysis is yet to be completed at Step S4 or S6, the print server device 2 according to the embodiment of the present invention is yet to receive all information required to determine whether the rule is to be applied and is thus unable to determine whether the rule is to be applied. The print server device 2 thus needs to receive subsequent print data yet to be received from the client terminal device 3.

If it is determined as a result of the determination made at Step S12 that there is existing a rule yet to be applied (Yes at Step S12), the job transmitting unit 20h temporarily stores the print data received this time in the external storage unit (HDD) 26 (Step S13). Then, the print server device 2 determines whether subsequent data exists (whether there is print data yet to be received from the client terminal device 3) (Step S19). If it is determined that there is subsequent print data (Yes at Step S19), the print server device 2 receives the subsequent print data (the predetermined amount of print data yet to be received) (Step S1). Based on the print data received, processing at Step S2 and subsequent steps is performed again (it is noted that determinations at Steps S2, S3, and S5 are already made and the results of the determinations may be inherited to skip these Steps).

The processing at Step S2 and subsequent steps may be performed again using print data obtained by combining the subsequent print data with the print data stored at Step S13. Additionally, a storage destination of the print data at Step S13 may be the external storage unit (HDD) 26 or a memory (not illustrated) mounted in the print server device 2.

If it is determined that there is no subsequent data (all print data has been received from the client terminal device 3) (No at Step S19), the print data is determined to not to be applied with the rule and is transmitted at Step S18.

In contrast, if it is determined as a result of the determination made at Step S12 that there are no more rules yet to be applied (No at Step S12), the job control determining unit 20f determines whether a control result to notify the user of a change in the output destination or the output form is transmitted to the client terminal device 3 (Step S14).

If it is determined as a result of the determination made at Step S14 that the control result is already transmitted (Yes at Step S14), the job transmitting unit 20h determines whether there is print data temporarily stored and relating to the current print job (that is, the print data stored at Step S13) (Step S16).

If it is determined as a result of the determination made at Step S16 that there is print data temporarily stored (Yes at Step S16), the job transmitting unit 20h reads the print data stored from the external storage unit (HDD) 26 (Step S17).

If it is determined as a result of the determination made at Step S16 that there is no print data temporarily stored (No at Step S16), or after the processing of reading at Step S17 is performed, it is next determined whether there is subsequent data (whether there is more print data yet to be received from the client terminal device 3) (Step S20). If it is determined that there is subsequent print data (Yes at Step S20), the job receiving unit 20a receives the subsequent print data (the predetermined amount of print data yet to be received) transmitted from the client terminal device 3 (Step S21) and the processing returns to Step S20.

In other words, reception of the predetermined volume of print data is repeated until all print data is received from the client terminal device 3 (until it is determined that there is no more subsequent print data).

If it is determined that there is no more subsequent print data (No at Step S20), which means that all print data has been transmitted from the client terminal device 3 to the print server device 2, the job transmitting unit 20h then transmits the print data (the print data received at Steps S1 and S21, or the print data read at Step S17 and the print data received) to the image forming device 4 specified as the output destination (Step S18). After this transmission is completed, the processing is completed.

An exemplary specific processing procedure of the flowchart illustrated in FIG. 8 will be described below.

The processing procedure is first described in a case where the print server device 2 receives print data constituting a print job (JOBC) that uses an application with an application name of Z from the client terminal device 3 based on a print instruction issued by a user who belongs to the group C, and has the image forming device 4B specified as the output destination.

In this case, when the print server device 2 receives a first print data constituting the print job (JOBC) at Step S1, the condition of “the application name is Z” and the processing of “changing to monochrome/duplex printing” are extracted as the relevant rule from the rule information table T2 at Step S2 based on the group name (group C) extracted from the job data portion of the print data.

At Step S3, the print server device 2 determines that a job analysis is necessary and then, at Step S4, analyzes the job attribute. Then, at Step S5, the print server device 2 determines that the page analysis is not necessary. At Step S8, the print server device 2 determines that the job editing is necessary. At Step S9, the print server device 2 edits the attribute information of the print job relating to the print data received to thereby change the attribute information to that to execute monochrome and duplex printing.

Then, at Step S10, the print server device 2 determines that the transmission destination does not need to be changed. At Step S12, the print server device 2 determines that there are no more rules yet to be applied. At Step S14, the print server device 2 determines that the job control determination result has not been transmitted. At Step S15, the print server device 2 transmits to the relevant client terminal device 3 the job control determination result, that is, the information to notify the user that the output form has been changed to that in which monochrome and duplex printing is executed.

Subsequently, at Step S16, the print server device 2 determines that there is no print data stored. At Step S20, the print server device 2 receives residual print data yet to be received from the client terminal device 3. At Step S18, the print server device 2 transmits the print data received to the image forming device 4B specified as the output destination, thus completing the processing.

The processing procedure is next described in a case where the print server device 2 receives, from a user who belongs to the group A, print data constituting a print job (JOBA) that yields the output cost of X or higher and has the image forming device 4B specified as the output destination.

In this case, when the print server device 2 receives the first print data constituting the print job (JOBA) at Step S1, the condition of “the output cost is X or higher” and the processing of “transmitting to the image forming device 4A” are extracted as the relevant rule from the rule information table T2 at Step S2 based on the group name (group A) extracted from the job data portion of the print data.

At Step S3, the print server device 2 determines that the job analysis is necessary and then, at Step S4, analyzes the job attribute. Then, at Step S5, the print server device 2 determines that the page analysis is necessary. At Step S6, the print server device 2 analyzes the page attribute. Subsequently, at Step S7, the print server device 2 attempts to calculate the cost (assume here that the print server device 2 fails to calculate the cost).

Subsequently, at Step S8, the print server device 2 determines that the job editing is not necessary. At Step S10, the print server device 2 determines temporarily that the transmission destination does not need to be changed, because the print server device 2 has failed to calculate the cost. Since the extracted rule cannot be applied unless the subsequent print data is received, the print server device 2 determines at Step S12 that there is the rule yet to be applied. At Step S13 thereafter, the print server device 2 temporarily stores therein the print data received.

At Step S19 thereafter, the print server device 2 determines that there is subsequent print data and, at Step S1, receives the subsequent print data. Processing of steps from Step S3 to Step S13->Step S19 is repeatedly performed until the cost is calculated (in this case, Step S2 is skipped).

When the cost is calculated at Step S7, and if the total output cost of the print job in question (JOBA) calculated at Step S7 is determined to be X or higher at Step S10, the image forming device as the output destination included in the attribute information of the print data constituting the print job in question (JOBA) is changed to the image forming device 4A defined through the processing included in the rule extracted at Step S2.

The print server device 2 thereafter determines at Step S12 that there are no more rules yet to be applied and determines at subsequent Step S14 that the job control determination result is not transmitted yet. At subsequent Step S15, the print server device 2 transmits to the client terminal device 3 a control result, that is, information to notify the user that the output destination has been changed to the image forming device 4A.

Subsequently, the print server device 2 determines at Step S16 that there is print data stored and, at Step S17, reads the print data stored and combines the print data read with the print data received. Thereafter, the print server device 2 combines residual print data yet to be received from the client terminal device 3 at Step S20. At Step S18, thereafter, the print server device 2 transmits the combined print data to the image forming device 4A that has been specified as the output destination and the processing is transferred to Step S19.

The embodiment of the present invention described heretofore is arranged such that, if a print job satisfies a predetermined condition, the image forming device as the output destination is automatically changed to one that yields lower output cost or the job attribute is automatically changed to a setting (monochrome/duplex printing) that yields lower output cost. The output cost to be incurred in the print job can therefore be reduced according to the intention of the system administrator without creating any extra work for the user.

In the embodiment described above, the rule information to be registered in the rule information table T2 includes a condition relating to the attribute (e.g., the application name or the document name) of the print job, other than the condition relating to the output cost of the print job. This enables forced change of a setting of the attribute information of a print job having low necessity of color/simplex printing, such as of e-mail, text editor, or browser printing, to a setting of monochrome/duplex printing. This also achieves cost reduction. Additionally, if the extracted relevant rule is one indicating, for example, an application name, the job information analysis is required to be performed only for the leading print data, which avoids sacrifice of first print performance.

In the embodiment described above, whether the rule is to be applied is determined before all print data is received, so that whether the rule is to be applied can be determined at a stage at which information required to determine whether the rule is to be applied is received. Whether the rule is to be applied can thus be quickly determined without having to wait for reception of all print data.

In general, the client terminal device 3 continuously transmits the predetermined amount of print data until all print data are transmitted. Thus, transmission of the print data and determination of whether the rule is to be applied are performed asynchronously and in parallel. As a result, there may be a case in which the client terminal device 3 completes transmission of a subsequent piece of print data before the print server device 2 determines whether there is the subsequent piece of print data. At this time, the subsequent piece of print data transmitted from the client terminal device 3 is stored in a predetermined storage area of the print server device 2, so that the print server device 2 takes out the subsequent piece of print data from the storage area. For convenience of explanation, in the embodiment of the present invention, even such a piece of print data is described as being yet to be received from the client terminal device 3.

In the embodiment described above, whether the rule is to be applied to the print data is determined before all print data to be output are received. This has an effect of enabling efficient processing. The present invention is therefore not limited to the above-described embodiment and is also used such that a rule to determine necessity of restricting (or controlling) the output data to be output is retained, the output data to be output is received, the necessity of restricting the output data is then determined based on the output data and the rule, and the output data is then provided (or used) while restricting the output data as necessary. A range over which the present invention is applied is not limited to print data.

For example, the present invention may be applied to a case in which, when output data is to be output to (displayed by) a projection device, whether to impose restriction on output is determined based on a certain rule (e.g., a page marked with “Strictly confidential” in page data is not to be displayed depending on a user).

The embodiment described above has been described for a case in which the print server device 2 performs the processing procedure illustrated in FIG. 8 as an information processing device. This is, however, not the only possible arrangement; alternatively, similar processing may be performed by another information processing device, such as the image forming device 4B or 4C as a multifunctional peripheral (MFP) or the client terminal device 3.

The embodiment described above has been described for a case in which the print data is once transmitted to the print server device 2. This is, however, not the only possible arrangement; alternatively, the print data may be transmitted directly from the client terminal device 3 to the image forming device 4.

Though not touched upon in the embodiment described above, an arrangement is also possible in which, when the output destination of a print job is to be changed to an image forming device that is a multifunctional peripheral (MFP), the job saving unit 40c in the image forming device (MFP) may be used to store therein the print job transmitted to thereby implement printing after storing.

Though not touched upon in the embodiment described above, an arrangement may still be made in which the system administrator can select whether to store or output the print job.

The embodiment described above has been described for a case in which the rule information table T2 registers rules (conditions and types of processing) in association with respective group names. This is, however, not the only possible arrangement; alternatively, the rule information table T2 may still register rules (conditions and types of processing) in association with respective user names. Still alternatively, the rule information table T2 may be configured so as to define an exceptional rule (e.g., an exceptional user/group condition, an exceptional job condition). This gives more flexibility in use.

In the embodiment described above, whether the rule is to be applied is determined each time the predetermined amount of print data is received from the client terminal device 3. As an alternative arrangement, Step S1 may be repeated until all data of the job data portion of the print data is received to make a first determination when all data of the job data portion is received; and, if there is a rule yet to be applied, Step S1 may be repeated until the rest of the print data, that is, all page data is received to make a second determination when all print data is available.

The embodiment described above has been described for a case in which the information processing system 1 includes one laser printer (LP) (specifically, the image forming device 4A) and two multifunctional peripherals (MFPs) (specifically, the image forming devices 4B and 4C) as the image forming device 4, and two client terminal devices 3. This is, however, not the only possible arrangement; alternatively, the information processing system 1 may include any number of image forming devices and client terminal devices.

Additionally, a computer program to execute the processing procedure in the embodiment described above may be provided by being incorporated in advance in the ROM, HDD, or other storage of the print server device 2 or the image forming device 4. The abovementioned computer program may also be provided by being recorded as a file of an installable or executable format on a computer readable recording medium. In addition, the abovementioned computer program may even be provided or distributed over a network, such as the Internet.

The present invention can reduce output cost relating to a print job in accordance with an intention of a system administrator without creating any extra work for a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a retaining unit that retains condition information to control an output setting of first output data based on a predetermined condition;
a receiving unit that receives second output data obtained by dividing the first output data into pieces each having a predetermined amount of data; and
a first determining unit that determines whether to control the output setting of the first output data based on the second output data, having the predetermined amount of data, and the condition information.

2. The information processing apparatus according to claim 1, further comprising:
a judging unit that judges whether determination to be made by the first determining unit is completed, wherein
the receiving unit receives, after having received the second output data, third output data obtained by dividing the first output data into the pieces each having the predetermined amount of data; and
the first determining unit determines, when the judging unit determines that the determination to be made by the first determining unit is yet to be completed, whether to control the output setting of the first output data based on the third output data received by the receiving unit and the condition information.

3. The information processing apparatus according to claim 2, further comprising:
a transmitting unit that transmits the first output data without causing the first determining unit to perform determination using the third output data when the judging unit judges that the determination to be made by the first determining unit is completed, wherein
the receiving unit receives the first output data that is transmitted in units of the predetermined amount of data.

4. The information processing apparatus according to claim 3, further comprising:
a setting unit that sets the output setting of the first output data based on the condition information when the first determining unit determines that the output setting of the first output data is to be controlled, wherein
the transmitting unit transmits the first output data under the output setting set by the setting unit.

5. The information processing apparatus according to claim 2, further comprising:
an acquiring unit that acquires the condition information on one or more conditions retained by the retaining unit based on the second output data having the predetermined amount of data received by the receiving unit.

6. The information processing apparatus according to claim 5, further comprising:
an analyzing unit that analyzes information required for the determination to be made by the first determining unit from the second output data or the third output data based on the condition information acquired by the acquiring unit, wherein
the first determining unit determines whether to control the output setting of the first output data based on the information analyzed by the analyzing unit from the second output data or the third output data and the condition information.

7. The information processing apparatus according to claim 5, further comprising:
a second determining unit that determines, based on the condition information acquired by the acquiring unit, whether the analysis to be made by the analyzing unit is necessary for a first data field and a second data field that constitute the first output data, wherein
the second output data is output data of the first data field; and
the third output data is output data of the second data field.

8. The information processing apparatus according to claim 7, wherein
the first data field is a field that constitutes attribute information of the first output data; and
the second data field is output data to be output of the first output data.

9. A computer program product comprising a non-transitory computer-usable medium having computer-readable program codes embodied in the medium, wherein the program codes when executed causing a computer to function as:
an acquiring unit that acquires, from a retaining unit that retains condition information to control an output setting of first output data based on a predetermined condition, the condition information; and
a first determining unit that determines whether to control the output setting of the first output data based on second output data and the condition information acquired by the acquiring unit, the second output data being obtained by dividing the first output data into pieces each having a predetermined amount of data and being received by a receiving unit.

10. A control method performed by an information processing apparatus that comprises a control unit, the control method comprising steps, performed by the control unit, of:
receiving second output data obtained by dividing first output data into pieces each having a predetermined amount of data;
acquiring, from a retaining unit that retains condition information to control an output setting of the first output data based on a predetermined condition, the condition information; and
making a first determination that determines whether to control the output setting of the first output data based on the second output data, having the predetermined amount of data, and the condition information acquired at the step of acquiring.
